(19) United States
(12) Patent Application Publication
(10) Pub. No.: US 2014/0125441 A1
(43) Pub. Date: May 8, 2014

(54) LARGE-CURRENT TRANSFORMER FOR ELECTRONIC ROUND POWER METER AND METHOD OF MAKING

(71) Applicants: Yin Hongping, Bengbu (CN); Qian Jinhua, Bengbu (CN); Yang Yuzhu, Bengbu (CN)

(72) Inventors: Yin Hongping, Bengbu (CN); Qian Jinhua, Bengbu (CN); Yang Yuzhu, Bengbu (CN)

(73) Assignee: An Hui Qian En Intelligent Technology Company Limited, Benbu, Anhui (CN)

(21) Appl. No.: 14/111,543

(22) PCT Filed: Apr. 13, 2012
(86) PCT No.: PCT/CN12/74012

§ 371 Date: Nov. 28, 2013

(30) Foreign Application Priority Data
Apr. 15, 2011 (CN) 201110095375.7

(51) Int. Cl. H01F 27/28; H01F 41/04

(52) U.S. Cl. CPC H01F 27/2852; H01F 41/04
USPC 336/174; 29/602.1

(57) ABSTRACT

Disclosed is a large-current transformer for an electronic round power meter, including a current sampling coil (2) and a current stick (1), where the current stick is a slotted stick, a middle section of the slotted stick is sleeved with the current sampling coil, inner slots at two ends of the slotted stick are inlaid with a first current insert (8) and a second current insert (10) respectively. The current transformer is easy to mount, has a reliable connection, a low temperature increase, high precision, and a low cost. A method of making the large-current transformer for an electronic round power meter includes: stamping a copper sheet into a flat current connector and a U-shaped current stick; where the U-shaped current stick passes through an inner hole of the current sampling coil, the flat current connector is inserted into inner slots at two ends of the U-shaped current stick, and the flat current connector is riveted firmly with the U-shaped current stick by means of riveting or spot welding. The method has fewer processes, high efficiency, and is suitable for large-batch production.

### BACKGROUND OF THE INVENTION

1. Technical Field

The present invention belongs to the field of electricity, and particularly to a large-current transformer for an electronic round power meter and method of making

2. Related Art

A large-current transformer is a closed annular device. It performs current sampling safely and easily after converting a large current of tens or hundreds of amperes into a small current of milliamperes. It is mainly used in high-current power meters, ampere meters, and a variety of current measurement and detection devices.

Previously, mechanical round power meters dominate many power meter markets in America, Asia, Africa, and especially, the United States. Such a power meter has the following characteristics, the meter housing is round, the power meter is independent of the terminals, and the power meter does no have a current transformer. A copper connector (similar to a plug) with a width of 18 mm-20 mm protrudes beyond the bottom of the power meter, and the corresponding terminal is provided with a slot matching the copper connector. The terminal is first mounted on a distribution box, and the power meter is connected and mounted in a plug-pull manner through the connector and the slot of the terminal.

With the rapid development of electronic meters in China and Europe, especially the rise of smart meters, these countries are quickly turning to electronic power meters. However, the connection manner of the plug-pull mounting of these electronic power meters has not been changed, and these power meters still use current transformers as a current signal sampling device. In the case that the size of the meter housing is limited, the size of the current transformer is restrained. Thus, the outer diameter of the current transformer should be within 50 mm, and the size of the inner hole must be less than 18 mm.

Currently, in order to develop a large-current transformer while meeting the above requirements at the same time, the two most typical practices are described as follows.

One practice is to design an integrated current stick large-current transformer. Such a transformer threads a large-current transformer with the size of an inner hole less than 18 mm on a round copper stick with a diameter of 7 mm-11 mm, the round copper stick is then bent to a U shape, two ends of the U shape are beaten into flat connectors, the width becomes 18 mm-20 mm, and the thickness conforms to the requirements. In this way, the transformers only can be produced one after another, the efficiency is very low, and the cost is also very high. After shaping, if the flat connector is not electroplated, it is easily to be oxidized, which affects use. If it is electroplated, the transform has been on the current stick, and if the transformer is put in the electroplating bath, the current transformer is easily damaged, or dipping in the high-temperature electroplating bath may directly affect its product performance.

The other practice is develop a two-part current stick large-current transformer, so as to solve the problem that the first manner does not facilitate electroplating. Some people make improvement on this basis. A round or square copper stick is cut into two parts, which are respectively bent into an L shape, one end of the L shape is beaten into a flat connector, the width of the connector becomes 18 mm-20 mm, and the thickness conforms to the requirements. Then electroplating is performed, the connector wears a transformer after electroplating, and two L shapes are joined from the middle, to become a U shape with two ends having flat connectors. Such a manner solves the effect of the electroplating on the transformer quality. However, it is very difficult to reliably join the cut current stick together after electroplating, and if the current stick is welded, the whole electroplating layer may be damaged, and two butting surfaces may not be completely welded together. Therefore, sometimes an insulating tape may be added outside for winding and binding. The efficiency is still very low. The cost is also very high, and if the current stick is not well joined after cutting, it may result in significantly decrease of over-current capability, the temperature increase is very high when operating with a large current, it may cause the meter to generate heat inside, which cannot be used well for a long time.

Therefore, a current transformer for electronic round power meters with low cost and high reliability, capable of long-term and stable use and accurate measurement is needed.

### SUMMARY

### Technical Problems

The present invention intends to solve the problem that the existing large-current transformer for the electronic round power meter has a high production cost, short use time and poor product performance.

### Technical Solutions

The large-current transformer for an electronic round power meter according to embodiments of the present invention includes a current sampling coil and a current stick. The current stick is a slotted stick, a middle section of the slotted stick is sleeved with the current sampling coil, and inner slots at two ends of the slotted stick are inlaid with a first current insert and a second current insert respectively.

The inlaid first current insert and second current insert are riveted together with the slotted stick through rivets respectively. The first current insert is provided with a protruding column welding surface for a first voltage sampling line, the second current insert is provided with a protruding column welding surface for a second voltage sampling line. A lower side of the protruding column welding surface for the first voltage sampling line is provided with a first voltage sampling lug threaded hole, and a lower side of the protruding column welding surface for the second voltage sampling line is provided with a second voltage sampling lug threaded hole.

The slotted stick is a U-shaped stick, which is formed by stamping of a copper sheet. The U-shaped stick is made by stamping a copper sheet having a thickness of 1.5 mm-2.5 mm, and a slot width of the U-shaped stick is about the same as a thickness of the first current insert or the second current insert.

Tops of the first current insert and the second current insert are provided with chamfered slopes. Structures of the first current insert and the second current insert are the same, and are flat current connectors, which are made by stamping a copper sheet having a thickness of 2 mm-2.6 mm and electroplating its surfaces. The flat current connectors have a plate width of 18 mm-20 mm, and have a height of 55 mm-80 mm.

A method of making the large-current transformer for an electronic round power meter according to embodiments of the present invention includes the following steps:

1) stamping a copper sheet having a thickness of 2 mm-2.6 mm into a flat current connector, wherein the flat current connector meets size requirements of the round power meter, and wherein the obtained flat current connector is electroplated, including tin-plated or nickle-plated; and

2) punching out a copper sheet having a thickness of 1.5 mm-2.5 mm into a U-shaped stick (U-shaped conductive beam), which can be electroplated depending on needs, and on surfaces of which, pickling and anti-oxidation treatment can be performed instead of electroplating.

The U-shaped stick passes through an inner hole of the current sampling coil, and then the current sampling coil is fixed onto the U-shaped stick in an appropriate manner.

Two electroplated flat current connectors are taken as the first current insert and the second current insert, to be respectively inserted into inner slots at two ends of the U-shaped stick already provided with the current sampling coil, and edges of the flat current connectors are aligned with end edges of the U-shaped stick. The flat current connector is riveted firmly with the U-shaped stick by means of riveting or spot welding. The flat current connectors double-face-contact the U-shaped stick, so that the flat current connector and the U-shaped stick have very good over-current capability and conductivity, which does not generate heat easily and maintains low temperature.

### Beneficial Effects

The products produced according to embodiments of the present invention can match well with a round power meter, are easily mounted, have reliable connections and low temperature increase, are resistant to a large rated current, have high precision, save copper materials, and have a low cost.

The producing method of embodiments of the present invention has fewer production processes, higher production efficiency, and is suitable for large-batch production.

### BRIEF DESCRIPTION OF THE DRAWINGS

FIG. 1 is a schematic structural view of a large-current transformer according to embodiments of the present invention; and

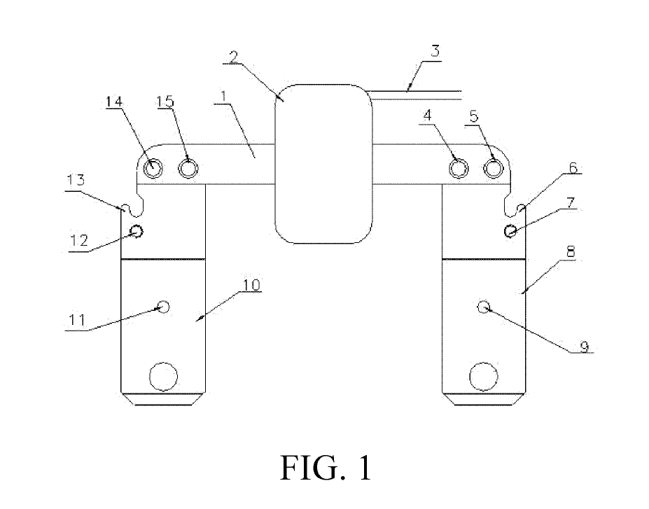

FIG. 2 is a schematic structural view showing that flat current connectors are firmly riveted in inner slots of a U-shaped stick through rivets.

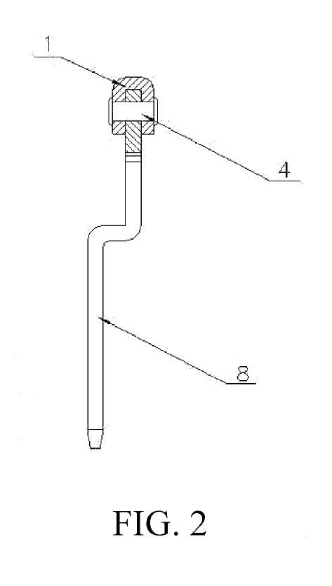

### DESCRIPTION OF THE PREFERRED EMBODIMENTS

As shown in the figures, a large-current transformer according to an embodiment of the present invention includes a current sampling coil 2 and a current stick, the current stick is a slotted stick 1, a middle section of the slotted stick 1 is sleeved with the current sampling coil 2, inner slots at two ends of the slotted stick 1 are inlaid with a first current insert 8 and a second current insert 10 respectively. The inlaid first current insert 8 is riveted firmly with the slotted stick 1 through rivets 4 and 5, the inlaid second current insert 10 is riveted firmly with the slotted stick 1 through rivets 14 and 15, and the riveting manner is machine-pressing riveting. The current sampling coil 2 is provided with a signal line 3. The first current insert 8 and the second current insert 10 are respectively provided with a limit hole 9 and a limit hole 11.

The first current insert 8 is provided with a first voltage sampling line protruding column welding surface 6, and the second current insert 10 is provided with a second voltage sampling line protruding column welding surface 13. A lower side of the protruding column welding surface 6 for the first voltage sampling line is provided with a first voltage sampling lug threaded hole 7, and a lower side of the protruding column welding surface 13 for the second voltage sampling line is provided with a second voltage sampling lug threaded hole 12.

The slotted stick 1 is a U-shaped stick, the U-shaped stick is formed by stamping a copper sheet having a thickness of 1.5 mm-2.5 mm, and a slot width of the U-shaped stick is basically the same as a thickness of the flat current connector.

Structures of the first current insert 8 and the second current insert 10 are about the same, both of which are flat current connector formed by stamping a copper sheet and are electroplated. They are stamped with a copper sheet having a thickness of 2 mm-2.6 mm. The flat current connector has a plate width of 18 mm-20 mm, and has a height of 55 mm-80 mm. Tops of the first current insert 8 and the second current insert 10 are provided with chamfered slopes.

A producing method of the large-current transformer includes the following steps:

1) stamping a copper sheet with a thickness of 2 mm-2.6 mm into a flat current connector, where the flat current connector meets size requirements of the round power meter, and the obtained flat current connector is electroplated, including tin-plated or nickle-plated;

2) using a copper sheet with a thickness of 1.5 mm-2.5 mm to punch out a U-shaped stick 1 (U-shaped conductive beam); where whether the U-shaped stick is electroplated is determined depending on needs, and pickling and anti-oxidation treatment are performed on a surface of the U-shaped stick if not electroplated; where the U-shaped stick 1 passes through an inner hole of the current sampling coil 2, and then the current sampling coil 2 is fixed onto the U-shaped stick in an appropriate manner.

Two electroplated flat current connectors are taken as the first current insert 8 and the second current insert 10, to be respectively inserted into inner slots at two ends of the U-shaped stick already provided with the current sampling coil 2, and edges of the flat current connectors are aligned with end edges of the U-shaped stick; and the flat current connector is riveted firmly with the U-shaped stick 1 by means of riveting or spot welding. The flat current connectors contact with the U-shaped stick 1 by double-face, so that the contact between the flat current connector and the U-shaped stick 1 have very good over-current capability and conductivity, which does not generate heat easily and have low temperature increase.

According to embodiments of the present invention, using the U-shaped stick 1 (U-shaped conductive beam) has the following advantages:

After the U-shaped stick 1 is stamped into a U shape through a plate, almost half of its own height may be reduced while a large current capability is ensured, so that it can easily pass through the inner hole of the current sampling coil 2, which reduces the size of the current transformer, and solves the problem that the current transformer cannot be mounted in the meter due to a too large size.

As the slot width of the inner slot of the U-shaped stick 1 is basically the same as the thickness of the flat current connector, after one end of the flat current connector is inserted into the inner slot of the U-shaped stick 1, they coordinate closely with each other. Besides, after they are riveted firmly by means of riveting or spot welding, they have better fixing and conducting effects, so that the entire assembled current stick can function as an excessive current similar to an integrated current stick although it is composed of several parts.

The two flat current connectors in the present invention are formed by stamping of a cooper plate, which are bilaterally symmetrical. According to the requirements that the power meter can operate only when obtaining a voltage, it provides two manners of obtaining a voltage, the first is to reserve a dedicated wire column for obtaining a voltage, where users can weld wires onto the wire column themselves, and the second is to reserve a threaded hole for obtaining a voltage, where customers can connect wires with connectors onto the flat current connector through fixing with screws.

What is claimed is:

1. A large-current transformer for an electronic round power meter, comprising a current sampling coil and a current stick, characterized in that, the current stick is a slotted stick, a middle section of the slotted stick is sleeved with the current sampling coil, inner slots at two ends of the slotted stick are inlaid with a first current insert and a second current insert respectively; and the inlaid first current insert and second current insert are riveted together with the slotted stick through rivets respectively.

2. The large-current transformer according to claim 1, characterized in that, the first current insert is provided with a protruding column welding surface for a first voltage sampling line, the second current insert is provided with a protruding column welding surface for a second voltage sampling line; a lower side of the protruding column welding surface for the first voltage sampling line is provided with a first voltage sampling lug threaded hole, and a lower side of the protruding column welding surface for the second voltage sampling line is provided with a second voltage sampling lug threaded hole.

3. The large-current transformer according to claim 1, characterized in that, the slotted stick is a U-shaped stick made by stamping a copper sheet having a thickness of 1.5 mm-2.5 mm; and a slot width of the U-shaped stick is about the same as a thickness of the first current insert or the second current insert.

4. The large-current transformer according to claim 1, characterized in that, tops of the first current insert and the second current insert are provided with chamfered slopes.

5. The large-current transformer according to claim 1, characterized in that, the first current insert and the second current insert are about the same in structure and are electroplated flat current connectors formed by stamping copper sheets having a thickness of 2 mm-2.6 mm, and the flat current connectors have a plate width of 18 mm-20 mm and a height of 55 mm-80 mm.

6. A method of making the large-current transformer according to claim 1, comprising the following steps:
1) stamping a copper sheet with a thickness of 2 mm-2.6 mm into a flat current connector, wherein the flat current connector meets size requirements of the round power meter, and the obtained flat current connector is electroplated;
2) using a copper sheet with a thickness of 1.5 mm-2.5 mm to punch out a U-shaped stick; wherein whether the U-shaped stick is electroplated is determined depending on needs, and pickling and anti-oxidation treatment are performed on a surface of the U-shaped stick if not electroplated;
wherein the U-shaped stick passes through an inner hole of the current sampling coil, and the current sampling coil is fixed onto the U-shaped stick in an appropriate manner; and
wherein two electroplated flat current connectors are taken as the first current insert and the second current insert, to be respectively inserted into inner slots at two ends of the U-shaped stick already provided with the current sampling coil; and the flat current connector is riveted firmly with the U-shaped stick by means of riveting or spot welding.
